(19) United States
(12) Patent Application Publication
(10) Pub. No.: US 2022/0072649 A1
(43) Pub. Date: Mar. 10, 2022

(54) DEVICES, SYSTEMS, AND METHODS FOR ENCODING AND DECODING DATA IN AN ADDITIVE MANUFACTURING BUILD CHAMBER

(71) Applicant: ARCAM AB, Molnlycke (SE)

(72) Inventor: David Svensson, Molndal (SE)

(73) Assignee: ARCAM AB, Molnlycke (SE)

(21) Appl. No.: 17/014,627

(22) Filed: Sep. 8, 2020

(51) Int. Cl. B23K 15/00; B33Y 30/00; B33Y 50/02; B23K 15/02

(52) U.S. Cl. CPC B23K 15/0086; B33Y 30/00; B23K 15/02; B23K 15/0026; B23K 15/0033; B33Y 50/02

(57) ABSTRACT

Additive manufacturing systems, and methods of encoding and decoding data within a build chamber of an additive manufacturing system are disclosed. An additive manufacturing system includes a build chamber having a patterned surface, the patterned surface having indicia therein or thereon. The additive manufacturing system further includes an energy beam (EB) gun configured to emit an energy beam and a sensor configured to detect one or more x-ray emissions that are generated as a result of impingement of the energy beam on the patterned surface. The one or more x-ray emissions include characteristics that correspond to the indicia such that data encoded in the indicia can be obtained from the characteristics of the one or more x-ray emissions.

### FIELD

The present disclosure relates to devices, systems, and methods for utilizing emissions within a build chamber as a result of an additive manufacturing process, and more specifically, for encoding data in patterns that correspond to particular emissions within a build chamber.

### BACKGROUND

In additive manufacturing processes, particularly those that utilize electron-beam melting of a powder layer to create an article, various emissions, such as x-ray emissions or the like, result from application of an energy beam. When an energy beam traverses a particular pattern on a surface (e.g., a shape engraved in a surface, various surface features of a surface, and/or the like), the emissions that result from energy beam impingement change in accordance with the pattern.

### SUMMARY

In a first aspect, an additive manufacturing system includes a build chamber having a patterned surface, the patterned surface having indicia therein or thereon. The additive manufacturing system further includes an energy beam (EB) gun configured to emit an energy beam and a sensor configured to detect one or more x-ray emissions that are generated as a result of impingement of the energy beam on the patterned surface. The one or more x-ray emissions include characteristics that correspond to the indicia such that data encoded in the indicia can be obtained from the characteristics of the one or more x-ray emissions.

In a second aspect, a method of encoding data in a surface of a build chamber of an additive manufacturing system includes receiving, by a control component, data from a sensor communicatively coupled to the control component. The data corresponds to detected x-rays that are emitted as a result of impingement of an energy beam on the surface of the build chamber. The x-rays have characteristics that are indicative of a unique pattern on or in the surface of the build chamber. The method further includes storing the data in code repository and associating the data with corresponding data in the code repository. The corresponding data is encoded and accessible when subsequently accessed as a result of detecting x-ray signals that result from impingement of a subsequent energy beam on the surface of the build chamber.

In a third aspect, a method of decoding data stored in a patterned surface of a build chamber of an additive manufacturing system includes receiving, by a control component, data from a sensor communicatively coupled to the control component. The data corresponds to detected x-rays that are emitted as a result of impingement of an energy beam on the patterned surface of the build chamber, the x-rays having characteristics that are indicative of a unique pattern on or in the patterned surface of the build chamber. The method further includes extracting information from the data.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cutaway side view of an illustrative additive manufacturing system including sensor according to one or more embodiments shown and described herein;

FIG. 2A schematically depicts a detailed cross-sectional side view of an illustrative build platform within a build chamber of an additive manufacturing system according to one or more embodiments shown and described herein;

FIG. 2B schematically depicts a perspective view of an illustrative build platform within a build chamber of an additive manufacturing system according to one or more embodiments shown and described herein;

FIG. 3A schematically depicts a top down view of an illustrative surface within a build chamber having an illustrative pattern thereon according to one or more embodiments shown and described herein;

FIG. 3B schematically depicts a top down view of an illustrative surface within a build chamber having an illustrative surface feature according to one or more embodiments shown and described herein;

FIG. 4A depicts a block diagram of illustrative internal components of a control component that encodes or decodes information in surface features or patterns in a surface of a build chamber of an additive manufacturing system according to one or more embodiments shown and described herein;

FIG. 4B depicts a block diagram of illustrative logic modules contained within a memory component of the control component of FIG. 3A according to one or more embodiments shown and described herein;

FIG. 5 depicts a flow diagram of an illustrative method of encoding data in indicia in a pattern or surface feature according to one or more embodiments shown and described herein; and

FIG. 6 depicts a flow diagram of an illustrative method of decoding data and/or encoding additional data in a pattern or surface feature in a surface of a build chamber according to one or more embodiments shown and described herein.

### DETAILED DESCRIPTION

The present disclosure generally relates to devices, systems, and methods that decode and/or encode data that is stored in geometric patterns on a surface within a build chamber of an additive manufacturing system. The patterns on the surface within the build chamber are generally patterns that are unique to the surface and can be basic geometric patterns, bar codes, three dimensional codes (e.g., QR codes), and/or the like. The patterns are generally formed as surface features within the surface such that when an energy beam moves over the pattern, the emissions as a result of the movement of the beam over the pattern (e.g., x-ray emissions) are particular to that pattern and can be used to sense the pattern, which, in turn, can be used to decode and/or encode data.

The transition into an industrialized system adds requirements of traceability and tracking to any system, particularly additive manufacturing systems. In some embodiments, such requirements include tracking consumables or tools used within the additive manufacturing system as well as adding “watermarks” to the end products. For example, it may be desired to track the number of times a particular component in an additive manufacturing system has been used, verify that a component or article of manufacture is an authentic component or authentic article of manufacture, verify that a component has not reached the end of its usable life, verify that a component is compatible with other components, and/or the like. An embedded pattern, embedded barcode, embedded matrix code, embedded 3D code, and/or the like in a surface of the component or article of manufacture allows for such tracking and verification because the code can be associated with an accessible record, as discussed in greater detail herein.

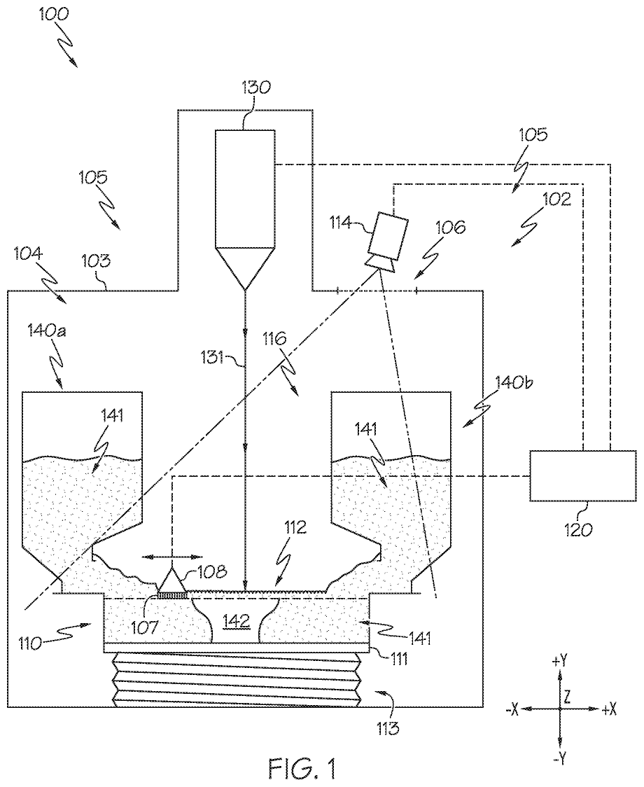

An illustrative additive manufacturing system that is used for the purposes of decoding and/or encoding data in a surface thereof (and/or an article manufactured therefrom) is depicted in FIG. 1, whereby a single sensor that has a field of view of the entire powder bed is used. While FIG. 1 depicts a single sensing device, it should be understood that any number of sensing devices may be used without departing from the scope of the present disclosure. For the purposes of brevity, the present disclosure will be described with respect to a single sensing device, particularly an x-ray sensing device.

Electron-beam additive manufacturing, which may also be known as electron-beam melting (EBM), is a type of additive manufacturing (3D printing) process that is typically used for metallic articles. EBM utilizes a raw material in the form of a metal powder or a metal wire, which is placed under a vacuum (e.g., within a vacuum sealed build chamber). Generally speaking, the raw material is fused together from heating via an energy beam.

Systems that utilize EBM generally obtain data from a 3D computer-aided design (CAD) model and use the data to place successive layers of the raw material using an apparatus to spread the raw material, such as a powder distributor. The successive layers are melted together utilizing a computer-controlled energy beam. As noted above, the process takes place under vacuum within a vacuum sealed build chamber, which makes the process suited to manufacture parts using reactive materials having a high affinity for oxygen (e.g., titanium). In embodiments, the process operates at higher temperatures (up to about 1000° C.) relative to other additive manufacturing processes, which can lead to differences in phase formation though solidification and solid-state phase transformation. At these higher temperatures, care must be taken to ensure that temperature fluctuations remain within a predetermined range to ensure correct formation of an article.

FIG. 1 depicts an embodiment of the present disclosure. As shown in FIG. 1, an additive manufacturing system 100 includes at least a build chamber 102, a sensor 114, an energy beam (EB) gun 130, and a control component 120. The build chamber 102 defines an interior 104 that is separated from an exterior environment 105 via one or more chamber walls 103. In some embodiments, at least a portion of the one or more chamber walls 103 of the build chamber 102 may include a window 106 therein. The sensor 114 is generally located adjacent to the build chamber 102 in the exterior environment 105 (i.e., not located within the interior 104 of the build chamber 102), and is arranged such that a field of view 116 of the sensor 114 extends through the window 106 into the interior 104 of the chamber.

In some embodiments, the interior 104 of the build chamber 102 may be a vacuum sealed interior such that an article 142 formed within the build chamber 102 is formed under optimal conditions for EBM, as is generally understood. The build chamber 102 is capable of maintaining a vacuum environment via a vacuum system. Illustrative vacuum systems may include, but are not limited to, a turbo molecular pump, a scroll pump, an ion pump, and one or more valves, as are generally understood. In some embodiments, the vacuum system may be communicatively coupled to the control component 120 such that the control component 120 directs operation of the vacuum system to maintain the vacuum within the interior 104 of the build chamber 102. In some embodiments, the vacuum system may maintain a base pressure of about 1×10⁻⁵ mbar or less throughout an entire build cycle. In further embodiments, the vacuum system may provide a partial pressure of He to about 2×10⁻³ mbar during a melting process.

In other embodiments, the build chamber 102 may be provided in an enclosable chamber provided with ambient air and atmosphere pressure. In yet other embodiments, the build chamber 102 may be provided in open air.

The build chamber 102 generally includes within the interior 104 a powder bed 110 supporting a powder layer 112 thereon, as well as a powder distributor 108. In some embodiments, the build chamber 102 may further include one or more raw material hoppers 140a, 140b that maintain raw material 141 therein. The build chamber 102 may further include other components, particularly components that facilitate EBM, including components not specifically described herein.

The powder bed 110 is generally a platform or receptacle located within the interior 104 of the build chamber 102 that is arranged to receive the raw material 141 from the one or more raw material hoppers 140a, 140b. The powder bed 110 is not limited in size or configuration by the present disclosure, but may generally be shaped and sized to hold an amount of the raw material 141 from the raw material hoppers 140a, 140b in the form of the powder layer 112, one or more portions of article 142, and/or unfused raw material 141, as described in greater detail herein.

In some embodiments, the powder bed 110 may include a movable build platform 111 supported by a lifting component 113. The movable build platform 111 may generally be a surface within the powder bed 110 that is movable by the lifting component 113 in a system vertical direction (e.g., in the +y/−y directions of the coordinate axes of FIG. 1) to increase and/or decrease a total volume of the powder bed 110. For example, the movable build platform 111 within the powder bed 110 may be movable by the lifting component 113 in a downward direction (e.g., toward the −y direction of the coordinate axes of FIG. 1) so as to increase the volume of the powder bed 110. In addition, the movable build platform 111 may be movable by the lifting component 113 to add each successive powder layer 112 to the article 142 being formed, as described in greater detail herein.

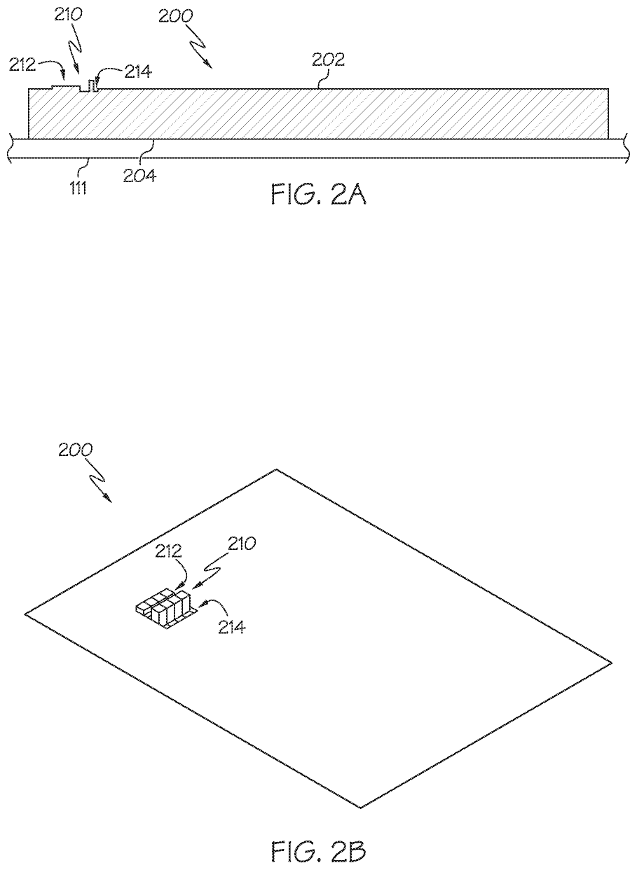

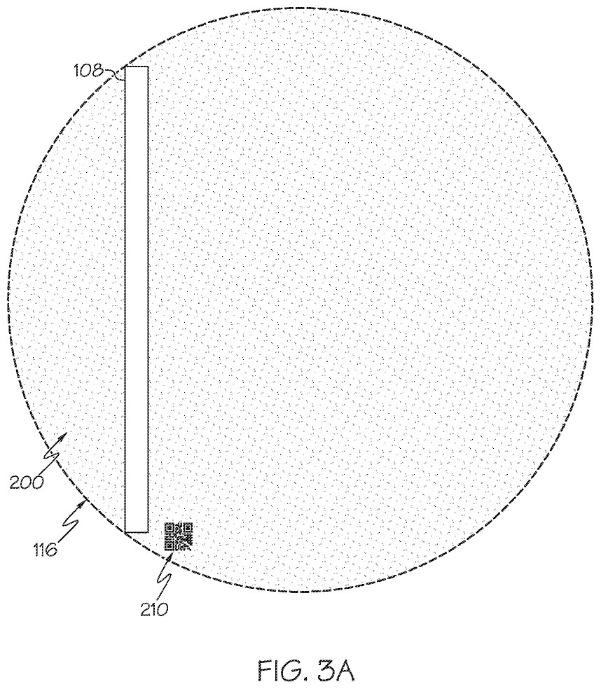

In some embodiments, the build chamber 102 further include a calibration plate (not shown) arranged on the build platform 111 for the purposes of calibrating the EB gun 130. In some embodiments, the calibration plate may be placed within the build chamber 102 prior to distribution of the raw material 141 from the raw material hoppers 140a, 140b on the build platform 111. In some embodiments, the calibration plate may be temporarily located within the build chamber 102 solely for the purposes of calibration before an EBM process (or between EBM processes), and thus is removed prior to distribution of the raw material 141 on the build platform 111 (hence the lack of depiction of the calibration plate in FIG. 1). Additional details regarding the calibration plate will be discussed herein with respect to FIGS. 2A-2B.

Still referring to FIG. 1, the lifting component 113 is not limited by the present disclosure, and may generally be any device or system capable of being coupled to the movable build platform 111 and movable to raise or lower the movable build platform 111 in the system vertical direction (e.g., in the +y/−y directions of the coordinate axes of FIG. 1). In some embodiments, the lifting component 113 may utilize a linear actuator type mechanism to effect movement of the movable build platform 111. Illustrative examples of devices or systems suitable for use as the lifting component 113 include, but are not limited to, a scissor lift, a mechanical linear actuator such as a screw based actuator, a wheel and axle actuator (e.g., a rack and pinion type actuator), a hydraulic actuator, a pneumatic actuator, a piezoelectric actuator, an electromechanical actuator, and/or the like. In some embodiments, the lifting component 113 may be located within the build chamber 102. In other embodiments, the lifting component 113 may be only partially located within the build chamber 102, particularly in embodiments where it may be desirable to isolate portions of the lifting component 113 that are sensitive to the harsh conditions (e.g., high heat, excessive dust, etc.) within the interior 104 of the build chamber 102.

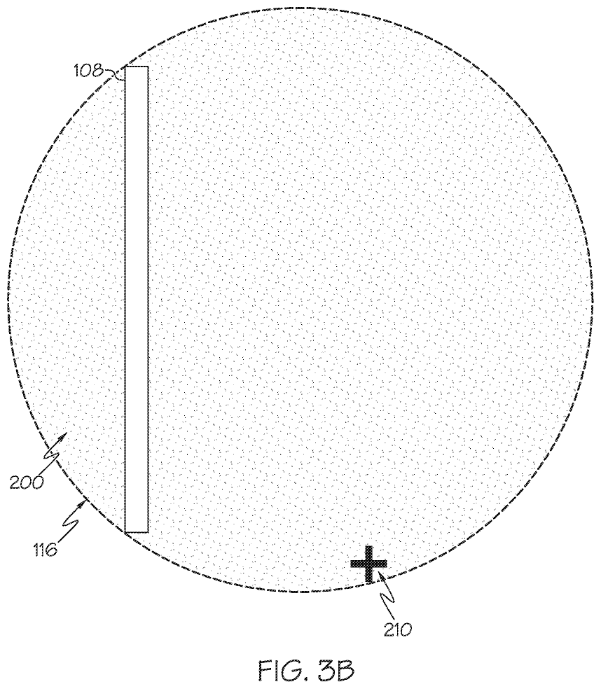

The powder distributor 108 is generally arranged and configured to lay down and/or spread a layer of the raw material 141 as the powder layer 112 in the powder bed 110 (e.g., on a start plate or the build platform 111 within the powder bed 110). That is, the powder distributor 108 is arranged such that movement of the powder distributor 108 is in a horizontal plane defined by the x-axis and the z-axis of the coordinate axes depicted in FIG. 1. For example, the powder distributor 108 may be an arm, rod, or the like (as depicted in FIGS. 3A-3B for example) that extends a distance in the z direction of the coordinate axes of FIG. 1 over or above the powder bed 110 (e.g., from a first end to a second end of the powder bed 110). Still referring to FIG. 1, in some embodiments, the length of the powder distributor 108 may be longer than a width of the build platform 111 such that the powder layer 112 can be distributed on each position of the build platform 111. In some embodiments, the powder distributor 108 may have a central axis in parallel with a top surface of the build platform 111 (e.g., generally parallel to the +x/−x axis of the coordinate axes of FIG. 1). One or more motors, actuators, and/or the like may be coupled to the powder distributor 108 to effect movement of the powder distributor 108. For example, a rack and pinion actuator may be coupled to the powder distributor 108 to cause the powder distributor 108 to move back and forth over the powder bed in the +x/−x directions of the coordinate axes of FIG. 1, as indicated by the double sided arrow depicted above the powder distributor 108 in FIG. 1. In some embodiments, movement of the powder distributor 108 may be continuous (e.g., moving without stopping, other than to change direction). In other embodiments, movement of the powder distributor 108 may be stepwise (e.g., moving in a series of intervals). In yet other embodiments, movement of the powder distributor 108 may be such that a plurality of interruptions occur between periods of movement.

As described in greater detail herein, the powder distributor 108 may further include one or more teeth 107 (e.g., rake teeth, rake fingers, or the like) that extend from the powder distributor 108 into the raw material 141 from the raw material hoppers 140a, 140b to cause disruption of the raw material 141 when the powder distributor 108 moves (e.g., to distribute the raw material 141, to spread the powder layer 112, etc.).

It should be understood that while the powder distributor 108 described herein generally extends a distance in the x direction of the coordinate axes depicted in FIG. 1 and moves in the +x/−x directions of the coordinate axes depicted in FIG. 1 to spread the powder layer 112 as described above, this is merely one illustrative example. Other configurations are also contemplated. For example, the powder distributor 108 may rotate about an axis to spread the powder layer 112, may articulate about one or more joints or the like to spread the powder layer 112, and/or the like without departing from the scope of the present disclosure.

In some embodiments, a cross section of the powder distributor 108 may be generally triangular, as depicted in FIG. 1. However, it should be understood that the cross section may be any shape, including but not limited to, circular, elliptical, quadratic, rectangular, polygonal or the like. A height of the powder distributor 108 may be set in order to give the powder distributor 108 a particular mechanical strength in the system vertical direction (e.g., along the +y/−y axis of the coordinate axes of FIG. 1). That is, in some embodiments, the powder distributor 108 may have a particular controllable flex in the system vertical direction. The height of the powder distributor 108 may also be selected taking into account that the powder distributor 108 pushes an amount of the raw material 141. If the height of the powder distributor 108 is too small, the powder distributor 108 can only push forward a smaller amount relative to a higher power powder distributor 108. However, if the height of the powder distributor 108 is too high, the powder distributor 108 may complicate the powder catching from a scree of powder, (e.g., the higher the height of the powder distributor 108, the more force may be required in order to catch a predetermined amount of powder from the scree of powder by moving the powder distributor 108 into the scree of powder and letting a predetermined amount of powder fall over the top of the powder distributor 108 from a first side in the direction of travel into the scree of powder to a second side in the direction of the build platform 111). In still yet other embodiments, the height of the powder distributor 108 may be such that areas adjacent to both a leading edge and a trailing edge of the powder distributor 108 are within a field of view 116 of the sensor 114, as described herein.

In some embodiments, the powder distributor 108 may be communicatively coupled to the control component 120, as depicted by the dashed line in FIG. 1 between the powder distributor 108 and the control component 120. As used herein, the term “communicatively coupled” generally refers to any link in a manner that facilitates communications. As such, “communicatively coupled” includes both wireless and wired communications, including those wireless and wired communications now known or later developed. As the powder distributor 108 is communicatively coupled to the control component 120, the control component 120 may transmit one or more signals, data, and/or the like to cause the powder distributor 108 to move, change direction, change speed, and/or the like. For example, a “reverse direction” signal transmitted by the control component 120 to the powder distributor 108 may cause the powder distributor 108 to reverse the direction in which it is moving (e.g., reverse movement in the +x direction to movement in the −x direction).

Each of the raw material hoppers 140a, 140b may generally be containers that hold an amount of the raw material 141 therein and contain an opening to dispense the raw material 141 therefrom. While FIG. 1 depicts two raw material hoppers 140a, 140b, the present disclosure is not limited to such. That is, any number of raw material hoppers may be utilized without departing from the scope of the present disclosure. Further, while FIG. 1 depicts the raw material hoppers 140a, 140b as being located within the interior 104 of the build chamber 102, the present disclosure is not limited to such. That is, the raw material hoppers 140a, 140b may be located outside or partially outside the build chamber 102 in various other embodiments. However, it should be understood that if a raw material hopper 140a, 140b is located outside or partially outside the build chamber 102, one or more outlets of the raw material hoppers 140a, 140b that supply the raw material 141 may be selectively sealed when not distributing the raw material 141 in order to maintain the vacuum within the build chamber 102.

The shape and size of the raw material hoppers 140a, 140b are not limited by the present disclosure. That is, the raw material hoppers 140a, 140b may generally have any shape and or size without departing from the scope of the present disclosure. In some embodiments, each of the raw material hoppers 140a, 140b may be shaped and or sized to conform to the dimensions of the build chamber 102 such that the raw material hoppers 140a, 140b can fit inside the build chamber. In some embodiments, the raw material hoppers 140a, 140b may be shaped and sized such that a collective volume of the raw material hoppers 140a, 140b is sufficient to hold an amount of raw material 141 that is necessary to fabricate the article 142, which includes a sufficient amount of material to form each successive powder layer 112 and additional material that makes up the unfused raw material 141.

The raw material hoppers 140a, 140b may generally have an outlet for ejecting the raw material 141 located within the raw material hoppers 140a, 140b such that the raw material 141 can be spread by the powder distributor 108, as described herein. In some embodiments, such as the embodiment depicted in FIG. 1, the raw material 141 may freely flow out of the raw material hoppers 140a, 140b under the force of gravity, thereby forming piles or scree of raw material 141 for the powder distributor 108 to spread. In other embodiments, the outlets of the raw material hoppers 140a, 140b may be selectively closed via a selective closing mechanism so as to only distribute a portion of the raw material 141 located within the respective raw material hoppers 140a, 140b at a particular time. The selective closing mechanisms may be communicatively coupled to the control component 120 such that data and/or signals transmitted to/from the control component 120 can be used to selectively open and close the outlets of the raw material hoppers 140a, 140b.

The raw material 141 contained within the raw material hoppers 140a, 140b and used to form the article 142 is not limited by the present disclosure, and may generally be any raw material used for EBM now known or later developed. Illustrative examples of raw material 141 includes, but is not limited to, pure metals such as titanium, aluminum, tungsten, or the like; and metal alloys such as titanium alloys, aluminum alloys, stainless steel, cobalt-chrome alloys, cobalt-chrome-tungsten alloys, nickel alloys, and/or the like. Specific examples of raw material 141 include, but are not limited to, Ti₆Al₄V titanium alloy, Ti₆Al₄V ELI titanium alloy, Grade 2 titanium, and ASTM F75 cobalt-chrome (all available from Arcam AB, Mölndal, Sweden). Another specific example of raw material 141 is INCONEL® alloy 718 available from Special Metals Corporation (Huntington W. Va.).

In embodiments, the raw material 141 is pre-alloyed, as opposed to a mixture. This may allow classification of EBM with selective laser melting (SLM), where other technologies like selective laser sintering (SLS) and direct metal laser sintering (DMLS) require thermal treatment after fabrication. Compared to SLM and DMLS, EBM has a generally superior build rate because of its higher energy density and scanning method.

The EB gun 130 is generally a device that emits an energy beam 131 (e.g., a charged particle beam), such as, for example, an electron gun, a linear accelerator, or the like. The EB gun 130 generates an energy beam 131 that may be used for melting or fusing together the raw material 141 when spread as the powder layer 112 on the build platform 111. In some embodiments, the EB gun 130 may include at least one focusing coil, at least one deflection coil and an energy beam power supply, which may be electrically connected to an emitter control unit. In one illustrative embodiment, the EB gun 130 generates a focusable energy beam 131 with an accelerating voltage of about 60 kilovolts (kV) and with a beam power in the range of about 0 kilowatts (kW) to about 10 kW. The pressure in the vacuum chamber may be in the range of about 1×10⁻³ mBar to about 1×10⁻⁶ mBar when building the article 142 by fusing each successive powder layer 112 with the energy beam 131. In some embodiments, the EB gun 130 may be communicatively coupled to the control component 120, as indicated in FIG. 1 by the dashed line between the EB gun 130 and the control component 120. The communicative coupling of the EB gun 130 to the control component 120 may provide an ability for signals and/or data to be transmitted between the EB gun 130 and the control component 120, such as control signals from the control component 120 that direct operation of the EB gun 130.

Still referring to FIG. 1, the sensor 114 is generally located in the exterior environment 105 outside the build chamber 102, yet positioned such that the field of view 116 of the sensor 114 is through the window 106 of the build chamber 102. The sensor 114 is generally positioned outside the build chamber 102 such that the harsh environment within the interior 104 of the build chamber 102 does not affect operation of the sensor 114. That is, the heat, dust, metallization, x-ray radiation, and/or the like that occurs within the interior 104 of the build chamber 102 will not affect operation of the sensor 114. In embodiments, the sensor 114 is fixed in position such that the field of view 116 remains constant (e.g., does not change). Moreover, the sensor 114 is arranged in the fixed position such that the field of view 116 of the sensor 114 encompasses an entirety of the powder bed 110. That is, the sensor 114 is capable of imaging the entire powder bed 110 within the build chamber 102 through the window 106.

In some embodiments, the sensor 114 is a device particularly configured to sense electromagnetic radiation, particularly x-rays that are generated by the various components within the powder bed 110 (e.g., the powder layer 112, the raw material 141, the article 142, and/or the calibration plate (FIGS. 2A-2B)). Still referring to FIG. 1, the sensor 114 may generally be a device particularly tuned or otherwise configured to obtain images in spectra where x-rays are readily detected, such as wavelengths of about 0.01 nanometers (nm) to about 10 nanometers. In some embodiments, the wavelength sensitivity of the sensor 114 may be selected in accordance with the type of raw material used and/or various other characteristics of components within the build chamber 102. Illustrative examples of suitable devices that may be used for the sensor 114 include, but are not limited to, a CCD camera (Charged Coupled Device-camera) that is particularly tuned for x-ray radiation, a CMOS-camera (Complementary Metal Oxide Semiconductor-camera) that is particularly tuned for x-ray radiation, a camera that integrates an x-ray tube, and/or the like. Such devices may be integrated with other components, such as, for example, vacuum sealed chambers, beryllium windows, phosphor screens, and/or the like.

In some embodiments, the sensor 114 may be an area scan camera that is capable of providing data specific to one or more regions of interest within the field of view 116. That is, an area scan camera includes a matrix of pixels that allows the device to capture a 2D image in a single exposure cycle with both vertical and horizontal elements. Area scan cameras can further be used to obtain a plurality of successive images, which is useful when selecting regions of interest within the field of view 116 and observing a change in the regions of interest. Illustrative examples of such area scan cameras include those available from Basler AG (Ahrensburg, Germany), JAI Ltd. (Yokohama, Japan), National Instruments (Austin, Tex.), and Stemmer Imaging (Puchheim, Germany).

In some embodiments, the sensor 114 may have a monochrome image sensor. In other embodiments, the sensor 114 may have a color image sensor. In various embodiments, the sensor 114 may include one or more optical elements, such as lenses, filters, and/or the like. In a particular embodiment, the sensor 114 may include a Bayer filter. As is generally understood, a Bayer filter is a color filter array (CFA) for arranging RGB color filters on a square grid of photosensors to create a color image, such as a filter pattern of about 50% green, about 25% red, and about 25% blue.

In some embodiments, the sensor 114 may further be a device particularly configured to provide signals and/or data corresponding to the sensed electromagnetic radiation (e.g., x-rays) to the control component 120. As such, the sensor 114 may be communicatively coupled to the control component 120, as indicated by the dashed lines depicted in FIG. 1 between the sensor 114 and the control component 120.

It should be understood that, by locating the sensor 114 in the exterior environment 105 outside the interior 104 of the build chamber 102, it is possible to easily retrofit existing build chambers having windows in the chamber walls 103 therein with a kit that includes the sensor 114 so as to upgrade the existing build chambers with the capabilities described herein.

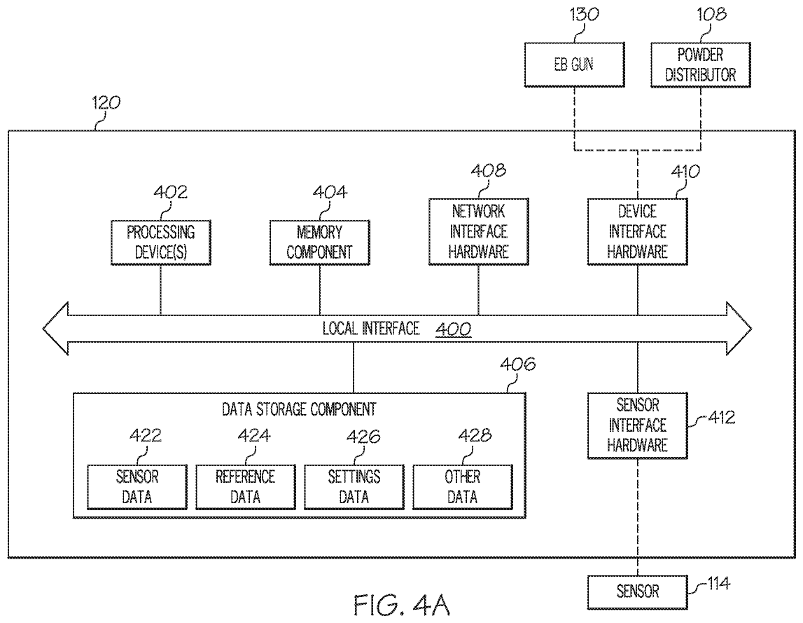

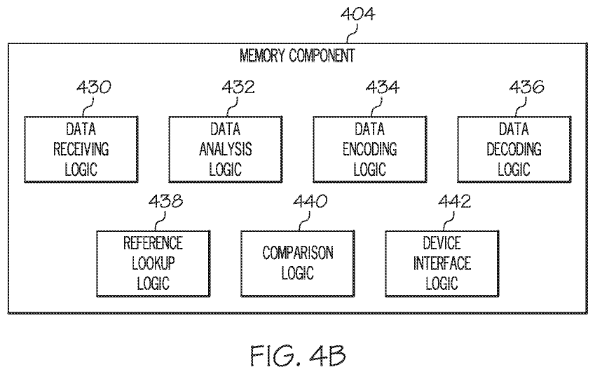

The control component 120 is generally a device that is communicatively coupled to one or more components of the additive manufacturing system 100 (e.g., the powder distributor 108, the sensor 114, and/or the EB gun 130) and is particularly arranged and configured to transmit and/or receive signals and/or data to/from the one or more components of the additive manufacturing system 100. Additional details regarding the control component 120 will be discussed herein with respect to FIGS. 4A-4B.

Referring to FIGS. 1 and 2A-2B, in some embodiments, a calibration plate 200 may be placed on top of the build platform 111 prior to distribution of the raw material 141 over the build platform 111. The calibration plate 200 may generally be placed prior to distribution of the raw material 141 for the purposes of calibrating the EB gun 130 prior to use of the EB gun 130 to form the article 142. As particularly shown in FIG. 2A, the calibration plate 200 may include a first major surface 202 and a second major surface 204 spaced apart from the first major surface 202. When the calibration plate 200 is arranged on the build platform 111, the second major surface 204 may be placed in contact with the build platform 111 while the first major surface 202 faces in the other direction (e.g., faces the EB gun 130).

As shown in FIGS. 2A-2B, the first major surface 202 may include a indicia 210 thereon. The indicia 210 may be a pattern such as a barcode, a matrix code (QR code), text, an image, and/or the like that can be used to encode information. For example, the indicia 210 may include a barcode, QR code or the like that provides information regarding the calibration plate 200, information regarding compatible additive manufacturing systems, information regarding articles that can be built, and/or the like. In another example, the indicia 210 may include data such as identification data (e.g., data that identifies a component that the indicia 210 is associated with), compatibility data (e.g., data that indicates which components are compatible with the component on which the indicia 210 is located (e.g., the calibration plate 200)), use number data (e.g., data pertaining to a number of uses of a component allowed in a lifetime of the component, the current number of uses, and/or the like), authenticity data (e.g., data that can be used to determine whether the component, and/or the like. In another example, the indicia 210 may be a serial number that can be used to identify the calibration plate 200. In yet another example, the indicia 210 may be standard surface features or components on or within the first major surface 202 (e.g., a screw head, a particular shape of the first major surface 202, or the like). That is, the indicia 210 may not be something extra that is added to the calibration plate 200, but rather the existing features of the calibration plate 200 are used to encode data therein.

In some embodiments, the information may be encoded directly into the indicia 210. That is, a “reading” of the indicia 210 according to the methods described herein directly extracts information from the indicia 210. In other embodiments, the indicia 210 may encode a link to a website, secure server, or the like that provides additional information. In yet other embodiments, the indicia 210 may encode information that is used when accessing a database, look-up table, and/or the like in order to obtain additional information. For example, the indicia 210 may provide an encoded alphanumeric string that corresponds to an entry in a database, look-up table, or the like.

In various embodiments, the indicia 210 may generally be etched into the first major surface 202 of the calibration plate 200. As such, the first major surface 202 of the calibration plate 200 may include one or more protrusions 212 and/or one or more recesses 214 therein. The one or more protrusions 212 may extend a distance outwardly from the first major surface 202 of the calibration plate 200 (e.g., away from the second major surface 204). The one or more recesses 214 may extend inwardly from the first major surface 202 of the calibration plate 200 (e.g., toward the second major surface 204). The one or more protrusions 212 and/or the one or more recesses 214 may generally form the indicia 210. As such, when an energy beam 131 is scanned over the indicia 210, the shorter distance traversed by the energy beam 131 (when scanning over the one or more protrusions 212) and/or the longer distance traversed by the energy beam 131 (when scanning over the one or more recesses 214) may cause varying electromagnetic radiation responses (e.g., varying x-rays emitted from impingement of the energy beam 131), which can be used to determine the various characteristics of the indicia 210 and to obtain information from the indicia 210, as described in greater detail herein. The amount of recorded x-rays is dependent on a distance between a location of where the energy beam 131 impinges (e.g., the indicia 210) and the sensor 114. This means that there will be contrast between surfaces at different elevations (e.g., the one or more protrusions 212 and/or the one or more recesses 214). Such contrast may allow for a multi-level encoding scheme which would significantly increase the spatial data density.

Generation of spatial contrast in the x-ray signal that results from impingement of the energy beam 131 on the indicia 210 can occur in a plurality of ways. For example, the indicia 210 may be formed of materials having different densities, which alters the amount of x-rays that are generated as a result of impingement (e.g., a higher density material results in more x-ray emissions). This could be achieved, for example, by electroplating the indicia 210 using a material with a higher or lower density than the calibration plate 200 or any other substrate that includes the indicia 210 (e.g., a thin copper bar code on an aluminum plate). Such an electroplating process may be suitable for “read-only” applications in the sense that the energy beam 131 cannot alter the density of the target material other than removing the target material by means of melting and/or evaporating.

In other embodiments, the indicia 210 may be formed to use shadows that occur from impingement of the energy beam 131 on the indicia 210 that is not in a line-of-sight of the sensor 114. That is, the energy beam 131 may be aimed on a hole portion of the indicia 210 that is sufficiently deep and small such that the sensor 114 does not have a direct line-of-sight to where the energy beam 131 hits the indicia 210, which results in a low signal being detected. In some embodiments, the energy beam 131 may form such a hole (e.g., melting the material to form the hole) for the purposes of encoding information, as described herein.

The calibration plate 200 may generally be any calibration plate used in various additive manufacturing systems (e.g., the Q10, Q20 and Spectra EBM systems available from Arcam AB (Mölndal, Sweden)). Conventionally, calibration plates are an example of a consumable tool which has a serial number without any automatic method for logging and tracking. As such, through use of the devices, systems, and methods described herein, recording the serial number of the calibration plate may become a part of a calibration procedure to ensure traceability of information, (e.g., traceability from the geometric certification of the calibration plate to the end product). As indicated hereinabove, the information encoded in the calibration plate 200 (e.g., within the indicia 210) does not have to be limited to the serial number. Each calibration plate 200 is conventionally measured to very high accuracy to ensure that the calibration plate 200 is manufactured according to the specifications. This information is only used for a pass/fail test. The accuracy of the calibration system is improved if the results from the measurement could be used during the calibration.

Accordingly, referring also to FIG. 1, when data is captured from radiation that reflects from the calibration plate 200 (e.g., data captured by the sensor 114, such as x-ray data or the like), the captured data indicates the indicia 210 thereon. For example, as depicted in FIGS. 3A-3B (while also referring to FIG. 1), the captured data corresponding to the radiation reflected from the calibration plate 200 and/or other components within the field of view 116 of the sensor (e.g., the powder distributor 108) includes the indicia 210. As shown in FIG. 3A, the various surface features of the calibration plate 200 at the indicia 210 (e.g., as depicted in FIGS. 2A-2B) are such that the data collected appears as a three dimensional code (e.g., a QR code). However, this is merely illustrative, as the various surface features of the calibration plate 200 at the indicia 210 are such that the data collected appears as a particular shape in other embodiments, such as the cross shape embodiment depicted in FIG. 3B. It should be understood that other patterns, barcodes, three dimensional codes, and/or the like may also be reflected as part of the indicia 210. The general shape, size, location, and/or the like of the indicia 210 may be used to encode data therein, as described in greater detail herein.

While the embodiments herein generally relate to the indicia 210 being on or within the calibration plate 200, the present disclosure is not limited to such. That is, the indicia 210 may be located in other areas of the build chamber 102 (FIG. 1) such as the build platform 111 (FIG. 1), may be located on an article being formed, or the like. Further, a plurality of indicia 210 may be used in some embodiments.

Turning to FIG. 4A, the various internal components of the control component 120 depicted in FIG. 1 are shown. Particularly, FIG. 4A depicts various system components for analyzing data received from the sensor 114 of FIG. 1 and/or assisting with the control of various components of the additive manufacturing system 100 depicted in FIG. 1.

As illustrated in FIG. 4A, the control component 120 may include one or more processing devices 402, a non-transitory memory component 404, a data storage component 406, network interface hardware 408, device interface hardware 410, and sensor interface hardware 412. A local interface 400, such as a bus or the like, may interconnect the various components.

The one or more processing devices 402, such as a computer processing unit (CPU), may be the central processing unit of the control component 120, performing calculations and logic operations to execute a program. The one or more processing devices 402, alone or in conjunction with the other components, are illustrative processing devices, computing devices, processors, or combinations thereof. The one or more processing devices 402 may include any processing component configured to receive and execute instructions (such as from the data storage component 406 and/or the memory component 404).

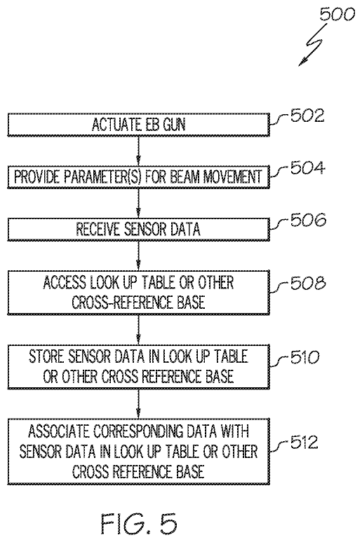

The memory component 404 may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. The memory component 404 may include one or more programming instructions thereon that, when executed by the one or more processing devices 402, cause the one or more processing devices 402 to complete various processes, such as the processes described herein with respect to FIG. 5.

Still referring to FIG. 4A, the programming instructions stored on the memory component 404 may be embodied as a plurality of software logic modules, where each logic module provides programming instructions for completing one or more tasks. FIG. 4B depicts the various modules of the memory component 404 of FIG. 4A according to various embodiments.

As shown in FIG. 4B, the memory component 404 includes a plurality of logic modules. Each of the logic modules shown in FIG. 4B may be embodied as a computer program, firmware, or hardware, as an example. Illustrative examples of logic modules present in the memory component 404 include, but are not limited to, data receiving logic 430, data analysis logic 432, data encoding logic 434, data decoding logic 436, reference lookup logic 438, comparison logic 440, and/or device interface logic 442.

Referring to FIGS. 4A and 4B, the data receiving logic 430 includes one or more programming instructions for receiving data from sensor 114 (e.g., x-ray related data). That is, the data receiving logic 430 may cause a connection between the sensor interface hardware 412 and the sensor 114 of FIG. 1 such that data transmitted by the sensor 114 is received by the control component 120. Further, the data transmitted by the sensor 114 may be stored (e.g., within the data storage component 406).

The data analysis logic 432 includes one or more programming instructions for analyzing data received from sensor 114. That is, the data analysis logic 432 contains programming for analyzing x-ray characteristics from the data that is received from the sensor 114. In some embodiments, the data analysis logic 432 contains programming for analyzing pixels contained within image data, determining groupings of pixels based on various characteristics, extracting information from pixels (e.g., brightness, intensity, color, and/or the like), and/or completing other image analysis tasks now known or later developed.

The data encoding logic 434 may include programming instructions for encoding data corresponding to the data that is received from the sensor 114. That is, a database, look-up table, or the like may be generated, updated, or amended to include the data received from the sensor 114 and any other corresponding data, such as parameter data, count data, and/or the like. For example, the data encoding logic 434 may include programming instructions that, when executed, cause the processing device 402 to direct storing of the data received from the sensor 114 (e.g., x-ray data corresponding to an identification of a start plate or a calibration plate) with data corresponding to one or more settings of the various components of the additive manufacturing system 100 (FIG. 1), data corresponding to a date and time the data from the sensor 114 was received, and/or the like in a database such that the data can be correlated and used for future reference.

Still referring to FIGS. 4A and 4B, the data decoding logic 436 and the reference lookup logic 438 may each include programming instructions for decoding data from a database, look-up table, or the like in response to particular data received from the sensor 114 in order to interpret what is encoded in the data associated with the sensor 114. For example, the data decoding logic 436 and/or the reference lookup logic 438 may contain programming instructions that, when executed, cause the processing device 402 to access a database, find a match that corresponds to the data received from the sensor 114, and obtain data that correlates to the match (e.g., calibration data that is used for the purposes of calibrating the EB gun 130 (FIG. 1)).

The comparison logic 440 generally includes one or more programming instructions for comparing data received from the sensor 114 with data within a database, look-up table, or the like in order to find a match. That is, the comparison logic 440 may contain compare characteristics of the one or more regions captured within the data from the sensor 114 with the same one or more regions in a reference configuration, as stored in a database or look-up table. More specifically, the comparison logic 440 may contain programming instructions usable to determine differences in characteristics such as color, intensity, brightness, temperature, gradients, and/or the like for the purposes of comparing.

Referring to FIGS. 1, 4A, and 4B, the device interface logic 442 includes one or more programming instructions for establishing communicative connections with the various devices or components of the additive manufacturing system 100. For example, the device interface logic 442 may include programming instructions usable to establish connections with the powder distributor 108 and/or the EB gun 130 in various embodiments. In another example, the device interface logic 442 may contain programming instructions for working in tandem with the programming instructions of the data receiving logic 430 to establish connections with the sensor 114.

Referring again to FIG. 4A, the network interface hardware 408 may include any wired or wireless networking hardware, such as a modem, LAN port, wireless fidelity (Wi-Fi) card, WiMax card, mobile communications hardware, and/or other hardware for communicating with other networks and/or devices. For example, the network interface hardware 408 may be used to facilitate communication between external storage devices, user computing devices, server computing devices, external control devices, and/or the like via a network, such as, for example, a local network, the Internet, and/or the like.

The device interface hardware 410 may communicate information between the local interface 400 and one or more components of the additive manufacturing system 100. For example, the device interface hardware 410 may act as an interface between the local interface 400 and the EB gun 130 and/or the powder distributor 108. In some embodiments, the device interface hardware 410 may transmit or receive signals and/or data to/from the EB gun 130 and/or the powder distributor 108, transmit control signals to the EB gun 130 and/or the powder distributor 108 to effect control of the EB gun 130 and/or the powder distributor 108, and/or the like.

The sensor interface hardware 412 may communicate information between the local interface 400 and the sensor 114. In some embodiments, the sensor interface hardware 412 may transmit or receive signals and/or data to/from sensor 114, transmit control signals to the sensor 114 to effect control of the sensor 114, and/or the like.

Still referring to FIG. 4A, the data storage component 406, which may generally be a storage medium, may contain one or more data repositories for storing data that is received and/or generated. The data storage component 406 may be any physical storage medium, including, but not limited to, a hard disk drive (HDD), memory, removable storage, and/or the like. While the data storage component 406 is depicted as a local device, it should be understood that the data storage component 406 may be a remote storage device, such as, for example, a server computing device, cloud based storage device, or the like. Illustrative data that may be contained within the data storage component 406 includes, but is not limited to, sensor data 422, reference data 424, settings data 426, and/or other data 428. The sensor data 422 may generally be data that is obtained from the sensor 114. For example, the control component 120 may store the sensor data 422 as it is received from the sensor 114 for future reference. Still referring to FIG. 4A, the reference data 424 may be data stored in a database, look-up table, or the like, which is used for the purposes of encoding or decoding information within the data received from the sensor 114. The settings data 426 may be data pertaining to one or more components settings within the additive manufacturing system 100 (FIG. 1). Still referring to FIG. 4A, the other data 428 may generally be any other data that is usable for the purposes of determining characteristics or generated as the result of carrying out one or more processes described herein, useable or generated from a selection of one or more regions, providing feedback, directing movement, and/or the like, as described herein.

It should be understood that the components illustrated in FIG. 4A are merely illustrative and are not intended to limit the scope of this disclosure. More specifically, while the components in FIG. 4A are illustrated as residing within the control component 120, this is a nonlimiting example. In some embodiments, one or more of the components may reside external to the control component 120.

The various embodiments depicted in FIGS. 1, 2A-2B, 3A-3B, and 4A-4B should now generally be understood. That is, the embodiment depicted in FIG. 1 includes a sensor 114 located outside the build chamber 102 and has a field of view that encompasses the entire powder bed 110. In the embodiment depicted in FIG. 1, it is possible to capture data from the x-rays that are emitted as a result of impingement of the energy beam 131 on a surface, and use the captured data to encode or decode information using the various internal components described with respect to FIGS. 4A-4B and described in further detail below, the encoded or decoded information used for adjusting settings, counting a number of cycles, ensuring appropriate equipment, and/or the like.

In operation, during a work cycle (and after the calibration plate 200 has been imaged, as described herein), the build platform 111 may be lowered successively in relation to the EB gun 130 (e.g., in the −y direction of the coordinate axes depicted in FIG. 1) after each added powder layer 112 is placed. This means that the build platform 111 starts in an initial position, in which a first powder layer 112 of a particular thickness is laid down on the build platform 111. In some embodiments, the first powder layer 112 may be thicker than the other applied layers, so as to avoid a melt-through of the first layer onto the build platform 111. The build platform 111 is thereafter lowered in connection with laying down a second powder layer 112 for the formation of a new cross section of the article 142.

In an example embodiment, the article 142 may be formed through successive fusion of layers the raw material 141 supplied from the raw material hoppers 140a, 140b on the build platform 111 (e.g., successive fusion of layers of powder layer 112). Each layer corresponds to successive cross sections of the article 142. Such a fusion may be particularly completed based on instructions generated from a model the article 142. In some embodiments, the model may be generated via a CAD (Computer Aided Design) tool.

In embodiments, the EB gun 130 generates an energy beam 131 that, when contacting the raw material 141 located on the build platform 111, melts or fuses together the raw material 141 to form a first layer of the powder layer 112 on the build platform 111. In some embodiments, the control component 120 may be used for controlling and managing the energy beam 131 emitted from the EB gun 130. At least one focusing coil (not shown), at least one deflection coil, and an energy beam 131 power supply may be electrically connected or communicatively coupled to the control component 120, as indicated by the dashed lines between the control component 120 and the EB gun 130 in FIG. 1. In an illustrative embodiment, the EB gun 130 generates a focusable energy beam 131 with an accelerating voltage of about 60 kilovolts (kV) and with an energy beam 131 power in the range of about 0 kilowatts (kW) to about 3 kW. A pressure in the interior 104 of the build chamber 102 may be in the range of about 10⁻³ millibars (mBar) to about 10⁻⁶ mBar when constructing the article 142 by fusing each successive powder layer 112 with the energy beam 131.

In embodiments, a particular amount of raw material 141 may be provided on the build platform 111. The particular amount of raw material 141 is provided on the build platform 111 from one or more of the raw material hoppers 140a, 140b, in which the raw material 141 is ejected through the respective outlets on the raw material hoppers 140a, 140b, thereby creating a screen of raw material 141 on the build platform 111 (as well as the unfused raw material 141 on either side of the build platform 111).

It should be understood that the use and arrangement of the raw material hoppers 140a, 140b to supply the raw material 141 used for forming the powder layer 112 described herein is merely illustrative. That is, other arrangements of supplying and providing raw material 141, such as a powder container with a moving floor located outside the build chamber 102 or the like is also contemplated and included within the scope of the present disclosure.

In embodiments, a layer from the raw material 141 may be provided on build platform 111. The layer from the raw material 141 may then be collected by the powder distributor 108 by moving the powder distributor 108 a particular distance in a first direction (e.g., in a direction along the plane formed by the x-axis and the z-axis of the coordinate axes depicted in FIG. 1) into the scree of the raw material 141, thereby allowing a particular amount of the raw material 141 to fall over a top of the powder distributor 108. The powder distributor 108 is then moved in a second direction (e.g., in another direction along the plane formed by the x-axis and the z-axis of the coordinate axes depicted in FIG. 1). In some embodiments, the second direction may be opposite to the first direction. Movement of the powder distributor 108 in the second direction may remove the particular amount of the raw material 141, which has fallen over the top of the powder distributor 108, from the scree of the raw material 141.

The particular amount of the raw material 141 removed from the scree of the raw material 141 (or provided by any other suitable mechanism) in front of the powder distributor 108 (e.g., adjacent to a leading end of the powder distributor 108) may be moved over the powder bed 110 and/or the build platform 111 by means of the powder distributor 108 (including the teeth 107 thereof), thereby distributing the particular amount of the raw material 141 over the build platform 111.

In embodiments, a distance between a lower part of the teeth 107 and the upper part of the build platform 111 or a previous powder layer 112 determines the thickness of the portion of the raw material 141 distributed over the build platform 111 or the previous powder layer 112. That is, a thickness of the powder layer 112 can be adjusted by adjusting the height of the build platform 111.

The energy beam 131 emitted from the EB gun 130 may be directed over the build platform 111, thereby causing the powder layer 112 to fuse in particular locations to form a first cross section of the article 142 according to the model generated via the CAD tool. As noted herein, the energy beam 131 may be an energy beam or a laser beam. The energy beam 131 is directed over the build platform 111 from instructions given by the control component 120 or another device.

After a first powder layer 112 is finished (e.g., after the fusion of raw material for making a first layer of the article 142), a second powder layer 112 is provided on the first powder layer 112. The second powder layer 112 may be distributed according to the same manner as the previous layer, as described herein. However, in some embodiments, there might be alternative methods in the same additive manufacturing machine for distributing the raw material 141. For instance, a first layer may be provided by means of a first powder distributor and a second layer may be provided by a second powder distributor.

After the second powder layer 112 is distributed on the first powder layer 112, the energy beam 131 is directed over the build platform 111, causing the second powder layer 112 to fuse in selected locations to form a second cross section of the article 142. Fused portions in the second layer may be bonded to fused portions of said first layer. The fused portions in the first and second layer may be melted together by melting not only the material in the uppermost layer but also remelting at least a portion of a thickness of a layer directly below the uppermost layer.

In some embodiments, features in the article 142 may be constructed by a particular distribution of a powder layer 112 and subsequent fusion, resulting in a particular x-ray signature emitted from the powder layer 112, which can be used to encode information therein, as described herein. That is, formation of the article 142 may be such that indicia 210 is formed in the article 142 and the indicia 210 is used to encoded data therein.

FIG. 5 depicts an illustrative method 500 of encoding data in indicia 210 in a pattern or surface feature according to the embodiments depicted in FIGS. 1, 2A-2B, 3A-3B, and 4A-4B. The various processes of method 500 described with respect to FIG. 5 may generally be completed by the control component 120, except where specifically indicated otherwise. The processes described herein with respect to the method 500 of FIG. 5 assumes that a pattern or the like is formed in a surface of the additive manufacturing system 100, such as a pattern formed in a surface of the calibration plate 200.

Referring to FIGS. 1, 2A-2B, 3A-3B, and 4A-4B, and 5, the EB gun 130 may be actuated at block 502. That is, the EB gun 130 may be powered up or otherwise instructed to be placed in an active state (e.g., via one or more signals transmitted to the EB gun 130 from the control component 120).

At block 504, one or more parameters may be provided to various components of the additive manufacturing system 100 to direct movement of the energy beam 131. For example, the control component 120 may transmit one or more instructions to the EB gun 130 for adjusting one or more components of the EB gun 130 to ensure an appropriate energy beam 131 is emitted therefrom, impinges on the appropriate surface (e.g., the build platform 111, the calibration plate 200, the article 142, and/or the like), and/or moves in a particular direction, at a particular rate, and/or the like such that x-rays are emitted upon impingement of the energy beam 131 upon the surface, as described herein.

At block 506, the control component 120 receives sensor data from the sensor 114. That is, the sensor 114 detects the x-rays that are emitted upon impingement of the energy beam 131 upon a surface, as described herein, and transmits data and/or signals to the control component 120 that correspond to the detected x-rays. In some embodiments, the sensor data received from the sensor 114 may be a continuously-received stream of data. That is, x-rays may be continuously detected by the sensor 114 and data and/or signals corresponding thereto are continuously transmitted to the control component 120 as long as the x-rays are detected (e.g., whenever the EB gun 130 is emitting the energy beam 131). In some embodiments, the sensor data received from the sensor 114 may be received continuously for a predetermined period of time. In some embodiments, the sensor data received from the sensor 114 may be bursts of data that are received at predetermined intervals. In some embodiments, the sensor data received from the sensor 114 may be a single data transmission containing information pertaining to all detected x-rays for a predetermined period of time.

The subsequent processes of method 500 generally relate to associating the sensor data with other data so as to encode information in the features of the surface that generates a particular x-ray emission, as described herein. It should be understood that the subsequent processes are merely illustrative, and alternative and/or supplemental processes may also be completed.

At block 508, the control component 120 accesses a code repository (e.g., a look up table or other cross-reference base). That is, a database or the like that stores information relating to x-ray emissions and associated encoded information is accessed. For example, the reference data 424 of the data storage component 406 may be accessed in some embodiments. In another example, a blockchain hash corresponding to the reference link may be accessed. Accessing the look up table or other cross-reference base may generally include establishing a data connection between the control component 120 and the device or system for read and write access.

At block 510, the sensor data (or information associated with the sensor data) is stored in the code repository (e.g., the look up table or other cross-reference base). That is, the control component 120 may initiate a write function to write the sensor data (or information associated with the sensor data) to the code repository. For example, in some embodiments, the control component 120 may write the sensor data (or information associated with the sensor data) to the data storage component 406 (e.g., as part of sensor data 422). In some embodiments, storing the data to the code repository may include generating an image from the sensor data using image processing software, the image including an encoded symbol (e.g., a barcode or the like), extracting information from the encoded symbol, and storing the extracted information in the code repository.

At block 512, an association is made between the sensor data (or information associated with the sensor data) with corresponding data in the code repository (e.g., the look up table or other cross-reference base). That is, data to be encoded is written and associated with the sensor data (or information associated with the sensor data) according to block 512. In some embodiments, the data to be encoded may already be written in the data storage and/or memory and only an association (e.g., a cross reference or the like) is made to connect the data to be encoded with the sensor data (or information associated with the sensor data) according to block 512. In some embodiments, the data to be encoded may be a code or link to another database entry that includes stored data.

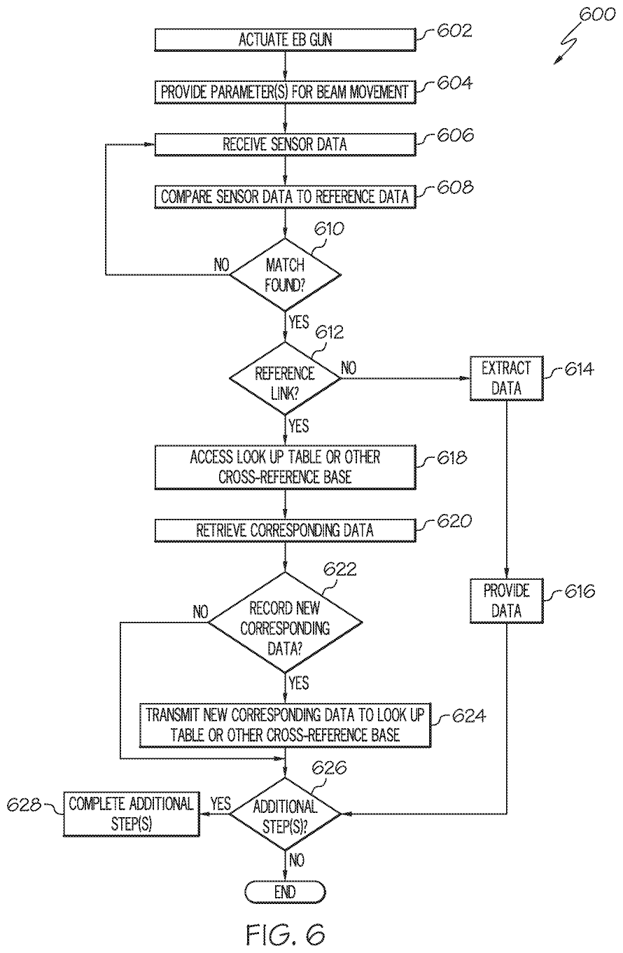

Accordingly, the various process of method 500 described herein allow for the particular surface features that result in a particular x-ray emission being detected to be associated with other data, thereby encoding the other data in the particular surface features. Thus, when the particular surface features are subsequently impinged with the energy beam 131, the same (or substantially the same) x-ray emissions will result, which can be detected and used to access the encoded data associated therewith, as described hereinbelow with respect to FIG. 6.

FIG. 6 depicts an illustrative method 600 of decoding data and/or encoding additional data in indicia 210 in a pattern or surface feature according to the embodiments depicted in FIGS. 1, 2A-2B, 3A-3B, and 4A-4B. The various processes of method 600 described with respect to FIG. 6 may generally be completed by the control component 120, except where specifically indicated otherwise.

Referring to FIGS. 1, 2A-2B, 3A-3B, 4A-4B, and 6, the EB gun 130 may be actuated at block 602. That is, the EB gun 130 may be powered up or otherwise instructed to be placed in an active state (e.g., via one or more signals transmitted to the EB gun 130 from the control component 120).

At block 604, one or more parameters may be provided to various components of the additive manufacturing system 100 to direct movement of the energy beam 131. For example, the control component 120 may transmit one or more instructions to the EB gun 130 for adjusting one or more components of the EB gun 130 to ensure an appropriate energy beam 131 is emitted therefrom, impinges on the appropriate surface (e.g., the build platform 111, the calibration plate 200, the article 142, and/or the like), and/or moves in a particular direction, at a particular rate, and/or the like such that x-rays are emitted upon impingement of the energy beam 131 upon the surface, as described herein.

At block 606, the control component 120 receives sensor data from the sensor 114. That is, the sensor 114 detects the x-rays that are emitted upon impingement of the energy beam 131 upon a surface, as described herein, and transmits data and/or signals to the control component 120 that correspond to the detected x-rays. In some embodiments, the sensor data received from the sensor 114 may be a continuously-received stream of data. That is, x-rays may be continuously detected by the sensor 114 and data and/or signals corresponding thereto are continuously transmitted to the control component 120 as long as the x-rays are detected (e.g., whenever the EB gun 130 is emitting the energy beam 131). In some embodiments, the sensor data received from the sensor 114 may be received continuously for a predetermined period of time. In some embodiments, the sensor data received from the sensor 114 may be bursts of data that are received at predetermined intervals. In some embodiments, the sensor data received from the sensor 114 may be a single data transmission containing information pertaining to all detected x-rays for a predetermined period of time. While not depicted as a process step in FIG. 6, in some embodiments, the sensor data may be stored within the data storage component 406 as part of sensor data 422.

The sensor data received from the sensor 114 may be extracted for use, as described herein with respect to blocks 608-620, for example.

At block 608, the sensor data received from the sensor 114 is compared to reference data and a determination is made at block 610 as to whether a match is found. That is, as the energy beam 131 impinges on a surface, x-ray emissions are reflected, detected by the sensor 114, and data is transmitted from the sensor to the control component 120 regardless of whether the reflected x-rays include encoded information therein. Since only reflected x-rays that include encoded information are used for the purposes of the present disclosure and the energy beam 131 may impinge on other surfaces that are not encoded, the comparison according to block 608 and the determination according to block 610 may be utilized. If the sensor data does not match reference data (block 610, match found? NO), the process may return to block 606. If the sensor data does match reference data (block 610, match found? YES), the process may proceed to block 612. In some embodiments, blocks 608 and 610 may be omitted, such as in embodiments where image processing is utilized to generate an image of a barcode or the like from the received sensor data and then information is extracted from the barcode image. In such embodiments, the process may proceed directly to block 612.

In some embodiments, the data that is encoded by the x-ray signal may be the data that is retrieved, or may be a reference link to a repository (e.g., a secure repository) that stores the like. For example, the data that is encoded by the x-ray signal may be a link to a private server, a key to a blockchain hash, or the like. Accordingly, at block 612, a determination is made as to whether the data encoded by the x-ray signal is a reference link. If the data is not a reference link (block 612, reference link? NO), the process proceeds to block 614. If the data is a reference link (block 612, reference link? YES), the process proceeds to block 618.

At block 614, the data is extracted by the control component 120. For example, the data is pulled from the data repository where it is stored and loaded into temporary storage for access. In some embodiments, block 614 may be omitted. At block 616, the data may be provided (e.g., to a user, an administrator, or the like). For example, the control component 120 may transmit the data to one or more computing devices (e.g., a user associated computing device). In another example, the control component 120 may display the data. The process may then proceed to block 626, as described hereinbelow.

At block 618, a code repository (e.g., a look up table or other cross-reference base) may be accessed. That is, a database or the like that stores information relating to x-ray emissions and associated encoded information is accessed. For example, the reference data 424 of the data storage component 406 may be accessed in some embodiments. In another example, a blockchain hash corresponding to the reference link may be accessed. Accessing the look up table or other cross-reference base may generally include establishing a data connection between the control component 120 and the device or system for read and/or write access.

At block 620, the data corresponding to the reference link is retrieved from the code repository (e.g., the look up table or other cross-reference base). That is, the control component 120 may retrieve a copy of the data stored in the code repository. In some embodiments, the data may be provided (e.g., to a user, an administrator, or the like). For example, the control component 120 may transmit the data to one or more computing devices (e.g., a user associated computing device). In another example, the control component 120 may display the data.

In some embodiments, additional data may be added to a record as a result of accessing the code repository. For example, if the encoded data pertains to a number of times the encoded signal is read (e.g., which may correspond to a number of times the energy beam 131 impinges on a surface, thereby resulting from the x-rays emitted therefrom), an indication of another time that encoded signal is read may be recorded. Accordingly at block 622, a determination is made as to whether new corresponding data is to be recorded. If new data is to be recorded (block 622, record new corresponding data? YES), the process may proceed to block 624. If new data is not to be recorded (block 622, record new corresponding data? NO), the process may proceed to block 626.

At block 624, the new corresponding data is transmitted (e.g., written) to the code repository (e.g., the look up table or other cross-reference base). That is, the control component 120 may initiate a write function to write the new corresponding data to the code repository. For example, in some embodiments, the control component 120 may write the new corresponding data to the data storage component 406.

In some embodiments, additional steps may be completed before the process ends. For example, in embodiments where the data corresponding to the sensor data that is accessed or retrieved indicates an error (e.g., an incompatible part is being used, a component has exceeded the number of times it can be used, a component has previously been indicated as not to be used, one or more settings/parameters need to be adjusted, and/or the like), additional steps such as deactivating one or more components, transmitting error messages, and/or the like may be completed. Accordingly, at block 626 a determination is made as to whether additional steps need to be completed. If so (e.g., block 626, additional steps(s)? YES), the process may proceed to block 628. If not (e.g., block 626, additional step(s)? NO), the process may end.

At block 628, the additional steps may be completed. For example, one or more components of the additive manufacturing system 100 may be deactivated, an error message may be transmitted, and/or the like may be completed according to block 628. Corrective action may be completed to correct any issues that may be present so that the process of method 600 can start over.

It should now be understood that that the devices, systems, and methods described herein decode and/or encode data that is stored in geometric patterns on a surface or as part of standard surface features of components within a build chamber of an additive manufacturing system. In some embodiments, the patterns on the surface within the build chamber are generally unique to the surface and can be basic geometric patterns, bar codes, three dimensional codes (e.g., QR codes), and/or the like. The patterns are generally formed as surface features within the surface such that when an energy beam moves over the pattern and impinges the surface, the emissions that result from the movement of the beam over the pattern are particular to that pattern and can be used to decode and/or encode data therein, including data stored in a database, a string of characters that can be used to access a database, a key to a blockchain hash, a link to a database, and/or the like. The encoded data can provide additional information about one or more components associated with the patterns on the surface.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Further aspects of the invention are provided by the subject matter of the following clauses:

1. An additive manufacturing system, comprising: a build chamber comprising a patterned surface, the patterned surface having indicia therein or thereon; an energy beam (EB) gun configured to emit an energy beam; and a sensor configured to detect one or more x-ray emissions that are generated as a result of impingement of the energy beam on the patterned surface, wherein the one or more x-ray emissions comprise characteristics that correspond to the indicia such that data encoded in the indicia can be obtained from the characteristics of the one or more x-ray emissions.

2. The additive manufacturing system of any preceding clause, further comprising a build platform, wherein the patterned surface is a surface of the build platform.

3. The additive manufacturing system of any preceding clause 1, further comprising an article of manufacture within the build chamber, wherein the patterned surface is a surface of the article of manufacture.

4. The additive manufacturing system of any preceding clause, further comprising a calibration plate, wherein the patterned surface is a surface of the calibration plate.

5. The additive manufacturing system of any preceding clause, wherein the calibration plate is removable from the build chamber.

6. The additive manufacturing system of any preceding clause, further comprising a control component communicatively coupled to the EB gun and the sensor, the control component configured to: direct the EB gun to emit the energy beam such that the energy beam impinges on the patterned surface; receive information from the sensor, the information including the data encoded in the indicia; and decode the data.

7. The additive manufacturing system of any preceding clause, wherein the indicia comprises one or more protrusions and one or more recesses in the patterned surface, the one or more protrusions and the one or more recesses arranged to encode data therein.

8. The additive manufacturing system of any preceding clause, wherein the indicia is a barcode, a matrix code, a 3D code, text, an image, or a surface feature of the patterned surface.

9. The additive manufacturing system of any preceding clause, wherein the data encoded in the indicia comprises one or more of identification data, compatibility data, use number data, and authenticity data.

10. The additive manufacturing system of any preceding clause, wherein the indicia provides an encoded alphanumeric string that corresponds to an entry in a database or look up table.

11. A method of encoding data in a surface of a build chamber of an additive manufacturing system, the method comprising: receiving, by a control component, data from a sensor communicatively coupled to the control component, the data corresponding to detected x-rays that are emitted as a result of impingement of an energy beam on the surface of the build chamber, the x-rays having characteristics that are indicative of a unique pattern on or in the surface of the build chamber; storing the data in code repository; and associating the data with corresponding data in the code repository, the corresponding data being encoded and accessible when subsequently accessed as a result of detecting x-ray signals that result from impingement of a subsequent energy beam on the surface of the build chamber.

12. The method of any preceding clause, further comprising: actuating an energy beam (EB) gun to cause the EB gun to emit the energy beam; and directing the EB gun to move the energy beam across the surface of the build chamber such that the energy beam impinges on the unique pattern.

13. The method of any preceding clause, wherein storing the data in the code repository comprises: generating an image from the data using image processing software, the image comprising an encoded symbol; extracting information from the encoded symbol; and storing the extracted information in the code repository.

14. A method of decoding data stored in a patterned surface of a build chamber of an additive manufacturing system, the method comprising: receiving, by a control component, data from a sensor communicatively coupled to the control component, the data corresponding to detected x-rays that are emitted as a result of impingement of an energy beam on the patterned surface of the build chamber, the x-rays having characteristics that are indicative of a unique pattern on or in the patterned surface of the build chamber; and extracting information from the data.

15. The method of any preceding clause, further comprising: actuating an energy beam (EB) gun to cause the EB gun to emit the energy beam; and directing the EB gun to move the energy beam across the patterned surface of the build chamber such that the energy beam impinges on the unique pattern.

16. The method of any preceding clause, wherein the patterned surface comprises indicia selected from a barcode, a matrix code, a 3D code, text, or a surface feature of the patterned surface.

17. The method of any preceding clause, wherein extracting information from the data comprises: generating an image from the data using image processing software, the image comprising the indicia; and extracting information from the indicia.

18. The method of any preceding clause, further comprising: comparing the information from the data to reference data in a database; and when a match is found in the reference data, extracting the reference data from the database.

19. The method of any preceding clause, further comprising adding additional data to a record corresponding to the information.

20. The method of any preceding clause, further comprising completing one or more additional steps selected from deactivating one or more components of the additive manufacturing system and transmitting an error message.

What is claimed is:

1. An additive manufacturing system, comprising:
a build chamber comprising a patterned surface, the patterned surface having indicia therein or thereon;
an energy beam (EB) gun configured to emit an energy beam; and
a sensor configured to detect one or more x-ray emissions that are generated as a result of impingement of the energy beam on the patterned surface,
wherein the one or more x-ray emissions comprise characteristics that correspond to the indicia such that data encoded in the indicia can be obtained from the characteristics of the one or more x-ray emissions.

2. The additive manufacturing system of claim 1, further comprising a build platform, wherein the patterned surface is a surface of the build platform.

3. The additive manufacturing system of claim 1, further comprising an article of manufacture within the build chamber, wherein the patterned surface is a surface of the article of manufacture.

4. The additive manufacturing system of claim 1, further comprising a calibration plate, wherein the patterned surface is a surface of the calibration plate.

5. The additive manufacturing system of claim 4, wherein the calibration plate is removable from the build chamber.

6. The additive manufacturing system of claim 1, further comprising a control component communicatively coupled to the EB gun and the sensor, the control component configured to:
direct the EB gun to emit the energy beam such that the energy beam impinges on the patterned surface;
receive information from the sensor, the information including the data encoded in the indicia; and
decode the data.

7. The additive manufacturing system of claim 1, wherein the indicia comprises one or more protrusions and one or more recesses in the patterned surface, the one or more protrusions and the one or more recesses arranged to encode data therein.

8. The additive manufacturing system of claim 1, wherein the indicia is a barcode, a matrix code, a 3D code, text, an image, or a surface feature of the patterned surface.

9. The additive manufacturing system of claim 1, wherein the data encoded in the indicia comprises one or more of identification data, compatibility data, use number data, and authenticity data.

10. The additive manufacturing system of claim 1, wherein the indicia provides an encoded alphanumeric string that corresponds to an entry in a database or look up table.

11. A method of encoding data in a surface of a build chamber of an additive manufacturing system, the method comprising:
receiving, by a control component, data from a sensor communicatively coupled to the control component, the data corresponding to detected x-rays that are emitted as a result of impingement of an energy beam on the surface of the build chamber, the x-rays having characteristics that are indicative of a unique pattern on or in the surface of the build chamber;
storing the data in code repository; and
associating the data with corresponding data in the code repository, the corresponding data being encoded and accessible when subsequently accessed as a result of detecting x-ray signals that result from impingement of a subsequent energy beam on the surface of the build chamber.

12. The method of claim 11, further comprising:
actuating an energy beam (EB) gun to cause the EB gun to emit the energy beam; and
directing the EB gun to move the energy beam across the surface of the build chamber such that the energy beam impinges on the unique pattern.

13. The method of claim 11, wherein storing the data in the code repository comprises:
generating an image from the data using image processing software, the image comprising an encoded symbol;
extracting information from the encoded symbol; and
storing the extracted information in the code repository.

14. A method of decoding data stored in a patterned surface of a build chamber of an additive manufacturing system, the method comprising:
receiving, by a control component, data from a sensor communicatively coupled to the control component, the data corresponding to detected x-rays that are emitted as a result of impingement of an energy beam on the patterned surface of the build chamber, the x-rays having characteristics that are indicative of a unique pattern on or in the patterned surface of the build chamber; and
extracting information from the data.

15. The method of claim 14, further comprising:
actuating an energy beam (EB) gun to cause the EB gun to emit the energy beam; and
directing the EB gun to move the energy beam across the patterned surface of the build chamber such that the energy beam impinges on the unique pattern.

16. The method of claim 14, wherein the patterned surface comprises indicia selected from a barcode, a matrix code, a 3D code, text, or a surface feature of the patterned surface.

17. The method of claim 16, wherein extracting information from the data comprises:
generating an image from the data using image processing software, the image comprising the indicia; and
extracting information from the indicia.

18. The method of claim 14, further comprising:
comparing the information from the data to reference data in a database; and
when a match is found in the reference data, extracting the reference data from the database.

19. The method of claim 14, further comprising adding additional data to a record corresponding to the information.

20. The method of claim 14, further comprising completing one or more additional steps selected from deactivating one or more components of the additive manufacturing system and transmitting an error message.
